(19) United States
(12) Patent Application Publication
(10) Pub. No.: US 2003/0181169 A1
(43) Pub. Date: Sep. 25, 2003

(54) In-vehicle wireless device providing telematics service with less power consumption

(76) Inventor: Katsuhiko Mutoh, Obu-City (JP)

Correspondence Address: HARNESS, DICKEY & PIERCE, P.L.C., P.O. BOX 828, BLOOMFIELD HILLS, MI, 48303, US

(21) Appl. No.: 10/368,266

(22) Filed: Feb. 18, 2003

(30) Foreign Application Priority Data
Mar. 22, 2002 (JP) 2002-081279

(51) Int. Cl. H04B 1/02

(52) U.S. Cl. 455/99; 455/91

(57) ABSTRACT

During an off-state of an ignition switch, a reception circuit and a transmission circuit of a station for telematics services in a vehicle are periodically shifted between an on-state and an off-state. As soon as a door knob of the vehicle is manipulated during the off-state of the ignition switch, the reception and transmission circuits along with a control circuit are shifted into the on-state even when staying in the off-state thereof. Thereby, a user can be, without waiting, provided with the telematics services associated with interface circuits for controlling operations relating to a vehicle body.

### CROSS REFERENCE TO RELATED APPLICATIONS

This application is based on and incorporates herein by reference Japanese Patent Application No. 2002-81279 filed on Mar. 22, 2002.

### FIELD OF THE INVENTION

The present invention relates to an in-vehicle wireless device that provides telematics service with enhancing convenience and with less power consumption.

### BACKGROUND OF THE INVENTION

An in-vehicle wireless device provides so-called telematics service by being integrated with a global positioning system (GPS), a wireless mobile phone, the Internet and others. As an instance of the telematics service, a door-lock-unlock service will be explained.

Referring to FIG. 5, as a user manipulates a cell phone 1 for locking (or unlocking) a door of a vehicle, the cell phone transmits a remote signal for locking the door.

The remote signal is transmitted to an electronic control unit of telematics (a telematics ECU) 3, as the in-vehicle wireless device, through a base station 2 of a cell phone network. The telematics ECU 3 thereby controls a door-lock control device 4 to lock the door. Thus the user can remotely manipulate the door of the vehicle using the cell phone 1.

However, the telematics ECU naturally needs to lower power consumption as much as possible during the off-state of the ignition switch of the vehicle.

As one solution of the above issue, the telematics ECU 3 remains in a sleep state (or a wait state) where it can at least receive the remote signal from the base station 2 even during the off-state of the ignition switch. The telematics ECU 3 can only periodically remain in the active state during the off-state of the ignition switch to save the power.

However, when the ECU 3 happens to remain in the sleep state, the remote signal from the cell phone 1 cannot control the door-lock control device due to the power-off of the relevant circuits of the telematics ECU 3. As a result, the user must wait for the telematics ECU 3 to enter the subsequent active state.

### SUMMARY OF THE INVENTION

It is an object of the present invention to provide an in-vehicle wireless device enhancing convenience with less power consumption.

To achieve the above object, an in-vehicle wireless device provided in a vehicle is provided with the following. The in-vehicle wireless periodically activates a wireless unit for wireless communication during an off-state of main power of the vehicle. It also activates the wireless unit when manipulating of a person outside the vehicle is detected during the off-state of the main power of the vehicle. The periodic activation of the wireless unit enables power consumption to be saved in comparison with constant activation. Furthermore, the wireless unit is activated whenever the manipulation of the person outside of the vehicle is detected. The person can thereby enjoy service provided by the in-vehicle wireless device without waiting for the next periodic activation of the wireless unit even when the wireless unit is not being activated. This structure provides convenient and power-efficient service.

It is preferable that the in-vehicle wireless device can control a door-lock control device that executes locking or unlocking of a door of the vehicle, a horn control device that sounds a horn of the vehicle, or a light control device that turns on a light of the vehicle. This enables the service of the in-vehicle wireless device to be extended. Furthermore, it is preferable that the wireless unit calls in a predetermined contact point when the wireless unit does not receive a predetermined remote signal for a predetermined period after being activated when the manipulating of the person outside the vehicle is detected. This prevents an illicit or violent operation to the vehicle.

### BRIEF DESCRIPTION OF THE DRAWINGS

The above and other objects, features and advantages of the present invention will become more apparent from the following detailed description made with reference to the accompanying drawings. In the drawings:

FIG. 1 is a structural block diagram showing an in-vehicle system according to a first embodiment of the present invention;

FIG. 2 is a flowchart diagram explaining processing of the in-vehicle system according to the first embodiment;

FIG. 3 is a flowchart diagram explaining processing of an in-vehicle system according to a second embodiment;

FIG. 4 is a flowchart diagram explaining processing of an in-vehicle system according to a third embodiment; and

FIG. 5 is a schematic view showing operation of telematics service.

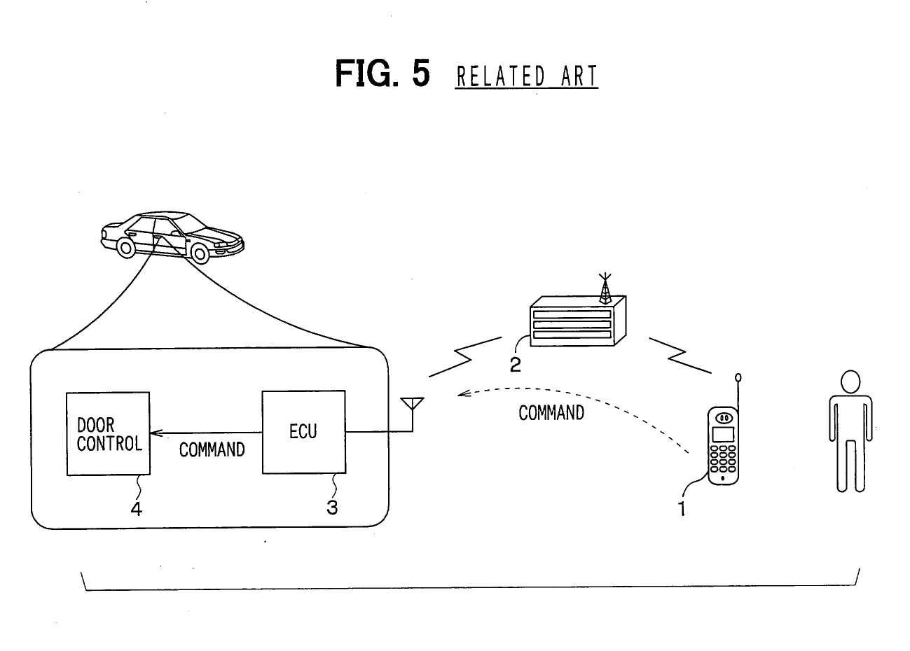

### DETAILED DESCRIPTION OF THE PREFERRED EMBODIMENTS

(First Embodiment)

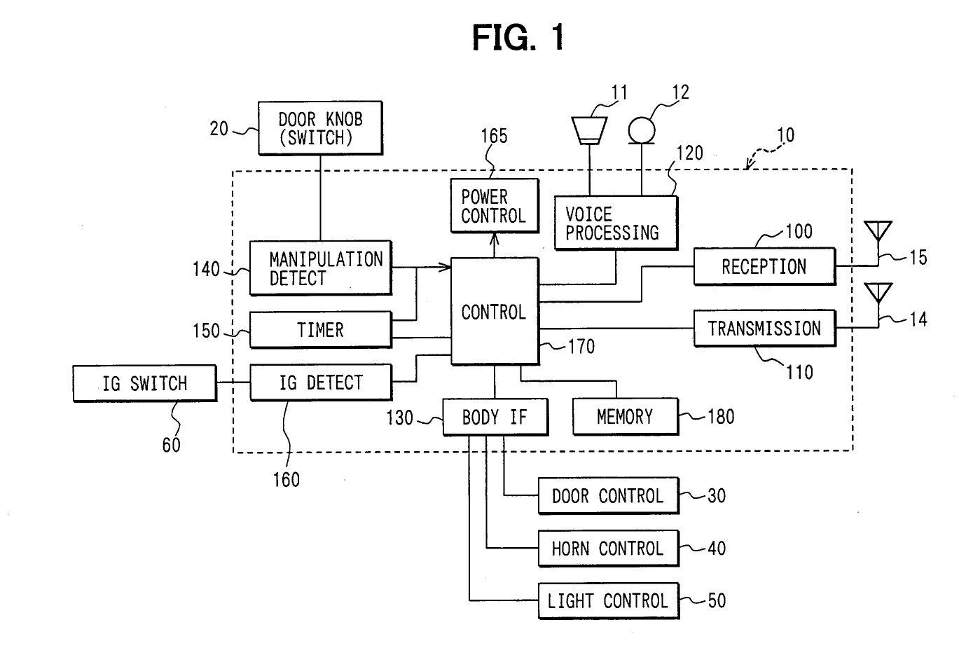

Referring to FIG. 1, an in-vehicle system provided in a vehicle includes a telematics electronic control unit (ECU) 10, a speaker 11, a microphone 12, a transmission antenna 14, a reception antenna 15, a door-knob switch 20, a door-lock control device 30, a horn control device 40, a light control device 50 and an ignition switch (IG) 60.

The telematics ECU 10 as an in-vehicle wireless device includes a reception circuit 100, a transmission circuit 110, a voice processing unit 120, a body control interface (IF) circuit 130, a person-manipulation detecting circuit 140, a timer circuit 150, an ignition detecting circuit 160, a power control circuit 165, a control circuit 170, and a memory 180.

The reception circuit 100 receives a downlink communication signal from a base station of a cell phone network through the reception antenna 15 to output a reception signal. By contrast, the transmission circuit 110 modulates a transmission signal to generate to transmit an uplink communication signal through the transmission antenna 14.

The voice processing unit 120 converts the reception signal, received from the reception circuit 100, from a digital signal to an analog signal and outputs reception voice via the speaker 11 based on the analog signal. It also converts output, from the microphone that accepts transmission voice, from an analog signal to a digital signal to generate the transmission signal to the transmission circuit 110.

The body control interface circuit 130 communicates with the door-lock control device 30, the horn control device 40, and the light control device 50.

The person-manipulation detecting circuit 140 detects output from the door-knob switch 20. The door-knob switch 20, being a constant-open type, is disposed near a door knob of the vehicle. The door-knob switch 20 turns on of off according to manipulation to the door knob by a person.

Here, the person-manipulation detecting circuit 140 along with the circuits 150, 160, and 170 is provided with electric power by an in-vehicle battery regardless of an on-state or an off-state of the ignition switch 60.

The timer circuit 150 counts to setting time instructed by the control circuit 170. Reaching the setting time, it outputs an interrupt signal to the control circuit 170. The ignition detecting circuit 160 detects manipulation to the ignition switch 60 by the person. The ignition switch 60 is for switching between an on-state and an off-state of an engine by the person's manipulation.

The power control circuit 165 is also constantly provided with the electric power from the in-vehicle battery regardless of the on-state or the off-state of the ignition switch 60. The power control circuit 165 controls power supply to the circuits 100, 110, 120, 130 and the memory 180.

The control circuit 170, being a CPU, is capable of shifting between an active state (or a wake-up state) and a sleep state (or a wait state). In the active state, the control circuit 170 executes processings for remote operations such as locking/unlocking of the door, a handsfree call through the speaker 11 and microphone 12, and low power consumption operation during the off-state of the ignition switch 60. In the sleep state, the control circuit 160 stops any processings except for a processing of awaiting the interrupt signal.

The memory 180, for instance formed of non-volatile memory, stores data accompanying processing by the control circuit 170 in addition to a computer program. The door-lock control device 30 locks or unlocks door-locking units. The horn control device 40 sounds a horn. The light control device 50 turns on or off lights provided in front and rear of the vehicle.

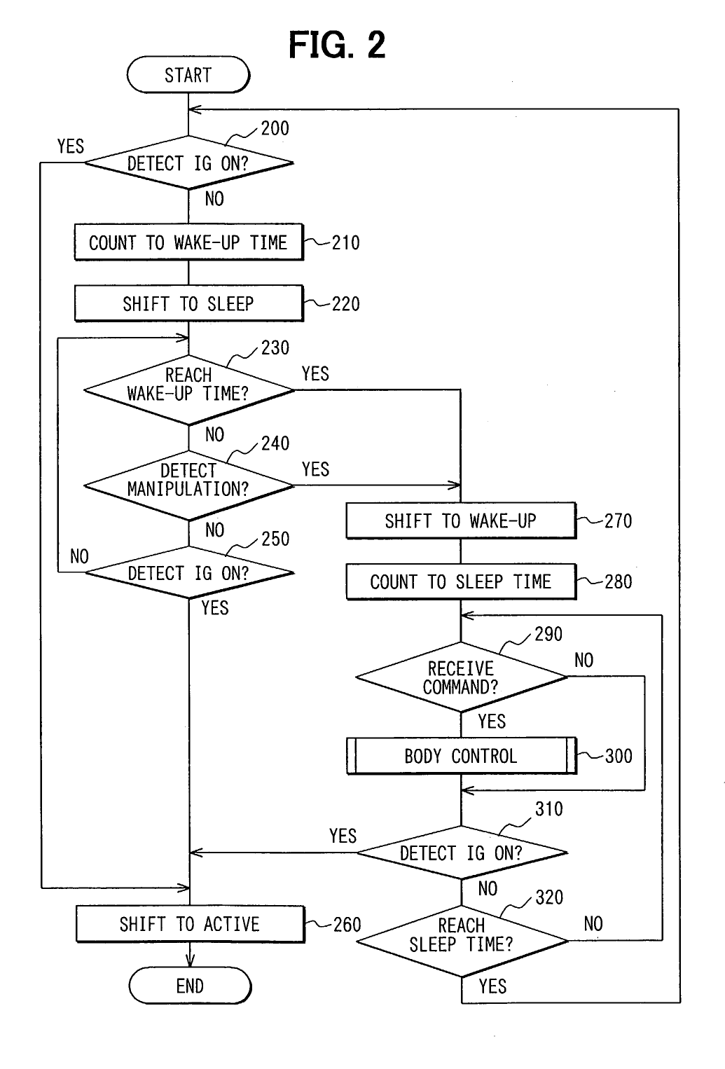

Next, processing of the embodiment for the low power consumption operation will be explained referring to FIG. 2.

At first, in the on-state (or normal operation state) of the ignition switch 60, the control circuit 170 stays in the normal active state. Here, the control circuit 170 controls the power control circuit 165 to power the circuits 100, 110, 120, 130, and the memory 180 to activate them.

When the ignition switch 60 is shifted into the off-state through the person manipulation, the control circuit 170 determines that the ignition switch 60 is in the off-state (NO at Step 200), based on the output of the ignition detecting circuit 160. At Step 210 the control circuit 170 then instructs the timer circuit 150 to start to count to a wake-up time (for instance 15 minutes).

At Step 220, the control circuit 170 shifts into the sleep state where any processing except for accepting the interrupt signal is stopped, while it controls the power control circuit 165 to stop to power to the circuits 100, 110, 120, 130, and 180. The person-manipulation detecting circuit 140, the timer circuit 150, and the ignition switch detecting circuit 160 are still in the active state with receiving the power.

At Step 230, whether the wake-up time is counted up is determined by observing the interrupt signal from the timer circuit 150. When the wake-up time is determined to be counted up, the processing proceeds to Step 270. When the wake-up time is determined to be not counted up, the processing proceeds to Step 240.

At Step 240, whether the person manipulation is detected is determined by observing the interrupt signal from the person-manipulation detecting circuit 140. The interrupt signal from the person-manipulation detecting circuit 140 is outputted when the person-manipulation detecting circuit 140 detects the on-state of the door-knob switch 20 shifted into by the manipulation to the door knob. When the person manipulation is determined to be detected, the processing also proceeds to Step 270. When the person manipulation is determined to be not detected, the processing proceeds to Step 250, where the ignition switch 60 is in the on-state is determined.

At Step 250, when the ignition switch 60 is determined to be in the off-state, the processing returns to Step 230. When the ignition switch 60 is determined to be in the on-state based on the interrupt signal from the ignition detecting circuit 160, the processing proceeds to Step 260. The interrupt signal from the ignition detecting circuit 160 is generated due to shifting into the on-state of the ignition switch 60.

At Step 260, the control circuits shifts into the normal active state and then the low power consumption operation is terminated.

At Step 270, the control circuit 170 shifts into the wake-up state and controls the power control circuit 165 to power to the circuits 100, 110, 130 and 180 to activate them as same as in the active state. Here, the wake-up state is equivalent to the active state during the low power consumption operation.

At Step 280, the control circuit 170 instructs the timer circuit 150 to start to count to a sleep time (for instance 10 minutes).

At Step 290, the control circuit 170 then determines whether a body control command from the base station 2 through the reception circuit 100 is received. The body control command from the base station 2 includes remote operation commands (or remote signals) such as a command for unlocking the door, a command for sounding the horn, and a command for turning the light. The remote operation command is transmitted from the cell phone 1, outside of the vehicle, through the base station 2. When the body control command is determined to be received, the processing proceeds to Step 300. By contrast, when it is determined to be not received, the processing proceeds to Step 310.

At Step 300, for instance, when the command for unlocking the door is received, the control circuit 170 controls the body control interface circuit 130 to output a door-unlock command to the door-lock control device 30. The relevant door of the vehicle is thereby unlocked.

At Step 310, whether the ignition switch 60 is in the on-state is determined after the completion of the processing at Step 300. When the ignition switch 60 is determined to be in the on-state, the processing proceeds to Step 260 where the control circuit 170 shifts into the active state. When the ignition switch 60 is determined to be in the off-state, the processing proceeds to Step 320, where whether the sleep time is counted up is determined.

At Step 320, when the sleep time is determined to be not counted up, the processing returns to Step 290. When the sleep time is determined to be counted up, the processing returns to Step 200.

As explained above, as soon as the door knob is manipulated even in the sleep state of the control circuit 170 during the off-state of the ignition switch 60, the control circuit 170 shifts into the active state to activate the circuits, which have been not powered. The user can thereby immediately enjoy the services using the circuits such as the reception circuit 100, the transmission circuit 110, and the body control interface circuit 130 without waiting for the following wake-up state of the control circuit 170. For instance, when the user remotely requests the door-unlock operation through the cell phone 1 outside of the vehicle, the door is immediately unlocked regardless staying in the sleep state or the wake-up state during the low power consumption operation.

(Second Embodiment)

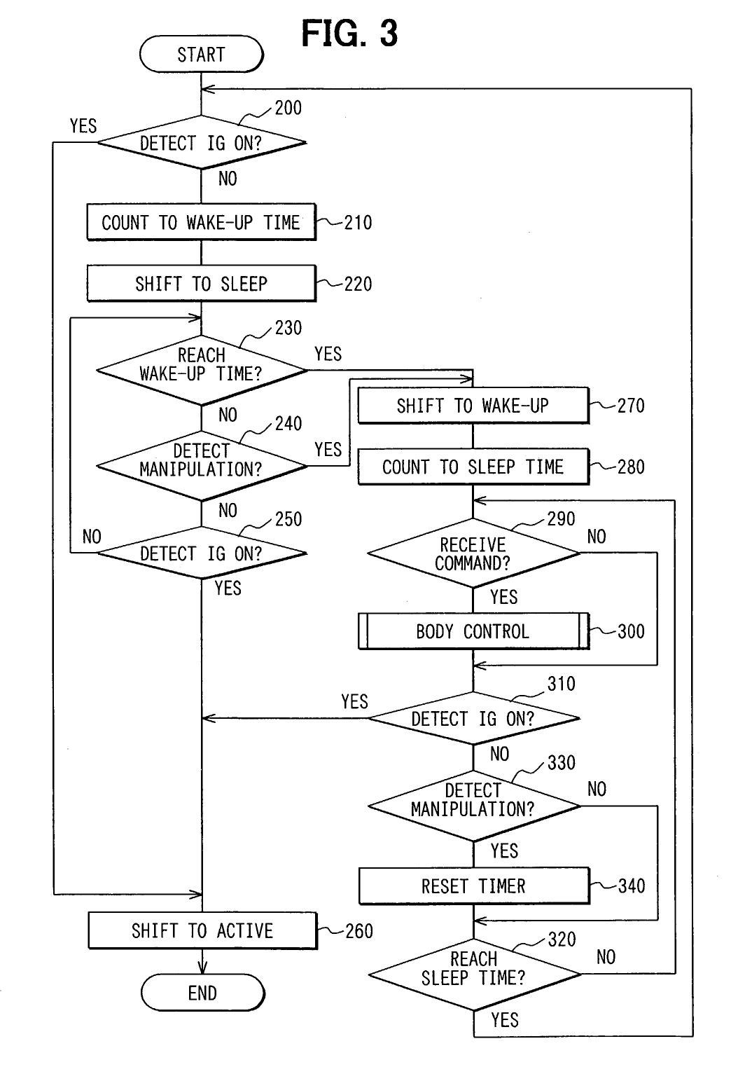

In a second embodiment, when the person manipulation is detected during the wake-up state of the control circuit 170, the sleep time is reset to enable restart of the wake-up state so that the period for providing the services can be extended. Referring to FIG. 3, only Steps 330 and 340 are additionally inserted between Steps 310 and 320 of the first embodiment in FIG. 2.

At Step 330, whether the person manipulation is detected during the wake-up state prior to Step 320 where whether the sleep time is counted up is determined as explained above. When the person manipulation is determined to be detected, the processing proceeds to Step 340. Here, the control circuit 170 instructs the timer circuit 150 to restart to count to the sleep time so that the wake-up state can be extended.

(Third Embodiment)

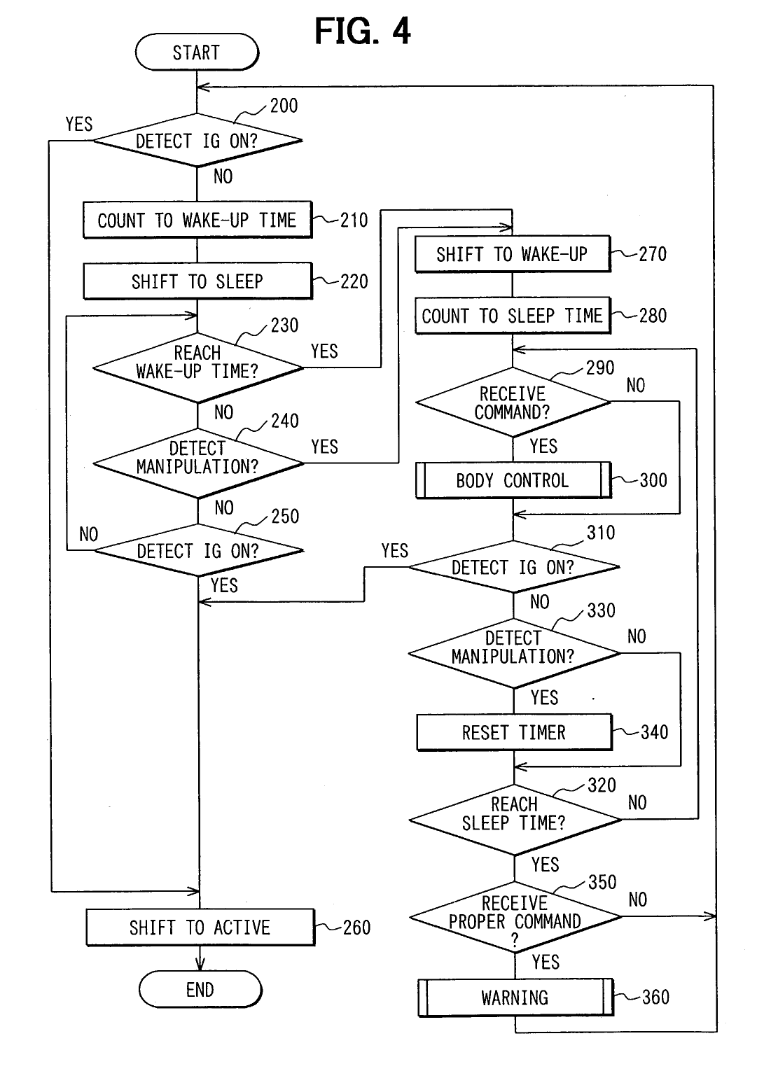

In a third embodiment, when no proper command is received after restarting of the wake-up state due to detecting the person manipulation, the improper manipulation is assumed to happen. The improper manipulation is then warned to the outside of the vehicle. Referring to FIG. 4, only Steps 350 and 360 are additionally inserted after Steps 320 of the second embodiment in FIG. 3.

At Step 350, the control circuit 170 determined at first whether the door knob is manipulated. When the door knob is determined to be manipulated, the control circuit 170 then waits for a proper command of unlocking the door for a predetermined period. The proper command of unlocking the door includes a reception signal received by the reception circuit 100 from the cell phone 1 through the base station 2 or a signal indicating that the unlocking of the door is executed by an ignition key.

When the proper command is determined to be not received, the control circuit 170 assumes that an improper manipulation happens and executes processing for warning the improper manipulation. For instance, the control circuit 170 controls the transmission circuit 110 to transmit a warning signal to the cell phone 1 of the user, the police, or a center for managing emergency services for the user. The improper manipulation such as an illicit or a violent operation is thereby notified to the outside of the vehicle.

(Modification)

The first, second and third embodiments can be modified below. Although the in-vehicle wireless device is mounted in the vehicle driven by the engine as a driving method, it can be mounted in an electric vehicle driven by an electric motor. Here, a motor switch for executing start or stop of the electric motor can be substituted for the ignition switch 60.

Although the manipulation to the door knob is adopted for detecting the person manipulation to the vehicle, any other manipulation to the outside of the vehicle such as manipulation to a body of the vehicle and a side-view mirror of the vehicle can be adopted.

Although the door-unlock operation as the remote operation from the cell phone 1 through the base station 2 is explained, other operations such as sounding the horn or turning on the light can be also adopted. Here, based on the received operation command, the control circuit 170 controls the horn control device 40 or the light control device to sound the horn or turn on the light respectively.

Although the remote operation command is transmitted from the cell phone 1 through the base station 2, it can be also transmitted from a fixed phone such as a public phone or a home phone. It can be transmitted by an operator in a center for providing remote services for the user. Here the operator can receive each request for the remote service from the user.

What is claimed is:

1. An in-vehicle wireless device that is provided in a vehicle, has a wireless unit for wireless communication, and periodically activates the wireless unit during an off-state of main power of the vehicle, the in-vehicle wireless device comprising:
detecting means for detecting manipulation of a person outside of the vehicle; and
activating means for activating the wireless unit when the detecting means detects the manipulating of the person outside the vehicle during the off-state of the main power of the vehicle.

2. An in-vehicle wireless device according to claim 1, further comprising:
extending means for extending an operation period of the wireless unit when the detecting means detects the manipulating of the person outside the vehicle during the off-state of the main power of the vehicle.

3. An in-vehicle wireless device according to claim 1,
wherein the detecting means detects manipulation, to a door knob of the vehicle, of the person as the manipulating of the person outside the vehicle.

4. An in-vehicle wireless device according to claim 1,
wherein the wireless unit communicates by wireless with a base station of a cell phone network.

5. An in-vehicle wireless device according to claim 1, further comprising:
door-lock controlling means for controlling, when the wireless unit receives an instruction signal for a door-lock control device of executing at least one of locking and unlocking a door of the vehicle, the door-lock control device to execute at least one of locking and unlocking the door of the vehicle based on the instruction signal.

6. An in-vehicle wireless device according to claim 1, further comprising:
horn controlling means for controlling, when the wireless unit receives an instruction signal for a horn control device of sounding a horn of the vehicle, the horn control device to sound the horn based on the instruction signal.

7. An in-vehicle wireless device according to claim 1, further comprising:
light controlling means for controlling, when the wireless unit receives an instruction signal for a light control device of turning on a light of the vehicle, the light control device to turn on the light based on the instruction signal.

8. An in-vehicle wireless device according to claim 1,
wherein the wireless unit calls in a predetermined contact point when the wireless unit does not receive a predetermined remote signal for a predetermined period after being activated when the detecting means detects the manipulating of the person outside the vehicle.

9. A constant detecting method for an in-vehicle wireless device that is provided in a vehicle, has a wireless unit for wireless communication, and periodically activates the wireless unit during an off-state of main power of the vehicle, the method comprising steps of:
detecting manipulation of a person outside of the vehicle; and
activating the wireless unit when the manipulating of the person outside the vehicle is detected during the off-state of the main power of the vehicle.
